(19) United States
(12) Patent Application Publication
(10) Pub. No.: US 2025/0153745 A1
(43) Pub. Date: May 15, 2025

(54) ARRANGEMENT FOR MONITORING A BEARING OF A SHEAVE ASSEMBLY

(71) Applicant: Innova Patent GmbH, Wolfurt (AT)

(72) Inventors: Stefan SACCAVINI, Dornbirn (AT); Stefan LINDER, Hohenems (AT)

(73) Assignee: Innova Patent GmbH, Wolfurt (AT)

(21) Appl. No.: 18/940,087

(22) Filed: Nov. 7, 2024

(30) Foreign Application Priority Data
Nov. 15, 2023 (AT) A50925/2023

(51) Int. Cl. B61B 12/02; G01M 13/04

(52) U.S. Cl. CPC B61B 12/02; G01M 13/04

(57) ABSTRACT

An arrangement for simplifying the monitoring of the bearings of a cableway, in particular of sheave assemblies on aerial lift pylons, for extending the maintenance intervals. At least one sensor is provided in the arrangement in a region of the bearing to detect a radial change in position of the sheave assembly relative to the axis of rotation from the target radial position. The at least one sensor is designed to interrupt or enable a current flow upon detecting a prespecified radial change in position of the sheave assembly relative to the axis of rotation from the target radial position in order to trigger an action.

### CROSS-REFERENCE TO RELATED APPLICATION

This application claims priority under 35 U.S.C. § 119 (a) to Austria Application No. A50925/2023 filed Nov. 15, 2023, the disclosure of which is expressly incorporated by reference herein in its entirety.

### BACKGROUND

### 1. Field of the Invention

Embodiments relate to an arrangement for monitoring a bearing of a sheave assembly of a cableway. The bearing comprises a receiving component and a component of the sheave assembly that is mounted on the receiving component via a connecting element so as to be pivotable about an axis of rotation. The sheave assembly is arranged in a target radial position with respect to the axis of rotation. The present invention also relates to a method for monitoring a bearing of a sheave assembly.

### 2. Discussion of Background Information

Cableways come in a wide variety of designs, mostly for the transportation of people and/or goods, e.g., as urban means of transportation or for the transportation of people in skiing areas. Cableway vehicles (e.g., with cabins, chairs, or other transportation containers) suspended from a cable are used for transportation. As a rule, cableways have at least two cableway stations, between which the cableway vehicles are moved via one or more aerial lift pylons by means of at least one cable.

The structure of an aerial lift pylon basically consists of a foundation, the pylon itself, and a cross-member, also called a crosshead, at the top end of the pylon. Aerial lift pylons can be designed as a steel lattice structure or as a steel tube or sheet metal box structure. A plurality of sheaves, e.g., in the form of a so-called sheave assembly, are usually arranged on an aerial lift pylon or on the cross-member in order to carry and guide the at least one cable with the cableway vehicles. Connecting elements such as pins are usually used to mount the sheave assemblies on the cross-member. If there is a plurality of sheave assemblies, these can also be mounted on an additional carrier, which is then mounted on the cross-member by means of pins.

In the case of cableways, the pins must be subjected to a crack test periodically after 15 years (30,000 operating hours) and then every 10 years (20,000 operating hours). This involves considerable effort. Particularly in the case of urban cableways, these crack tests must be carried out after just a few years (approx. 5 years) due to the very high number of operating hours per year. At the same time, there is the problem that due to their required availability urban cableways have little time for maintenance work.

### SUMMARY

Embodiments of the present invention simplify the monitoring of bearings of a cableway, in particular, of sheave assemblies on aerial lift pylons, to thereby extend maintenance intervals.

According to embodiments, an arrangement for monitoring a bearing of a sheave assembly in that at least one sensor is provided. The at least one sensor is arranged in a region of the bearing in order to detect a radial change in position of the sheave assembly relative to the axis of rotation from the target radial position. The at least one sensor is designed to interrupt or enable a current flow upon detecting a prespecified radial change in position of the sheave assembly relative to the axis of rotation from the target radial position in order to trigger an action. On the one hand, the bearing is constantly monitored by at least one sensor, such that it is possible to detect a prespecified radial change in position of the sheave assembly, for example, due to a worn or defective bearing, without inspecting the bearing. On the other hand, maintenance intervals, such as for crack testing, can be extended and the time required for maintenance work can be significantly reduced. In addition, it is advantageous that at least one sensor can also be integrated into existing cableways or aerial lift pylons.

In a preferred embodiment, the receiving component is an aerial lift pylon and the component of the sheave assembly is a carrier unit of the sheave assembly or a carrier of the sheave assembly. In another preferred embodiment, the receiving component is a carrier of the sheave assembly and the component of the sheave assembly is a carrier unit of the sheave assembly. Embodiments can therefore be applied to a wide variety of bearings in the region of a sheave assembly of a cableway.

Preferably, the at least one sensor is a limit switch or a proximity sensor. These types of sensors are reliable and available in a wide variety of embodiments.

In a preferred embodiment, the receiving component has at least one securing element for mounting the sheave assembly on the receiving component via the at least one securing element in the event of failure of the connecting element. Because the at least one sensor constantly monitors the bearing and, due to the at least one securing element, the sheave assembly remains mounted on the receiving component even if the connecting element fails, the maintenance intervals for periodic crack testing of the connecting element can be extended.

Preferably, the at least one securing element comprises the at least one sensor. In the event of the connecting element failing, the sheave assembly remains mounted on the receiving component via the at least one securing element. The sheave assembly comes into contact with at least one securing element. It is therefore advantageous to arrange at least one sensor in the region of this contact point of the securing element with the sheave assembly.

In an advantageous method for monitoring a bearing of a sheave assembly of a cableway, at least one sensor is provided. The sensor detects a prespecified radial change in the position of the sheave assembly relative to the axis of rotation from the target radial position and the at least one sensor interrupts or enables a current flow, thereby triggering an action. By the detection of the prespecified radial change in position of the sheave assembly, a defective bearing (e.g. due to excessive wear) can be detected at an early stage.

Preferably, the triggered action generates an alarm signal. This alarm signal can, for example, be communicated visually and/or acoustically to cableway personnel in a cableway control room. The alarm signal can also be used to stop the cableway in an emergency.

Other exemplary embodiments and advantages of the present invention may be ascertained by reviewing the present disclosure and the accompanying drawing.

### BRIEF DESCRIPTION OF THE DRAWINGS

The present invention is described in greater detail below with reference to FIGS. 1 to 5, which show schematic and non-limiting advantageous embodiments of the invention by way of example. In the figures:

FIG. 1 shows the basic structure of an arrangement for monitoring a bearing of a sheave assembly of a cableway;

FIG. 2 is a sectional view of the bearing of the sheave assembly;

FIG. 3 is a side view of a securing element with two sensors;

FIG. 4 shows a further embodiment of a bearing of a sheave assembly; and

FIG. 5 is a side view of the further embodiment of the bearing of the sheave assembly.

### DETAILED DESCRIPTION

The particulars shown herein are by way of example and for purposes of illustrative discussion of the embodiments of the present invention only and are presented in the cause of providing what is believed to be the most useful and readily understood description of the principles and conceptual aspects of the present invention. In this regard, no attempt is made to show structural details of the present invention in more detail than is necessary for the fundamental understanding of the present invention, the description taken with the drawings making apparent to those skilled in the art how the several forms of the present invention may be embodied in practice.

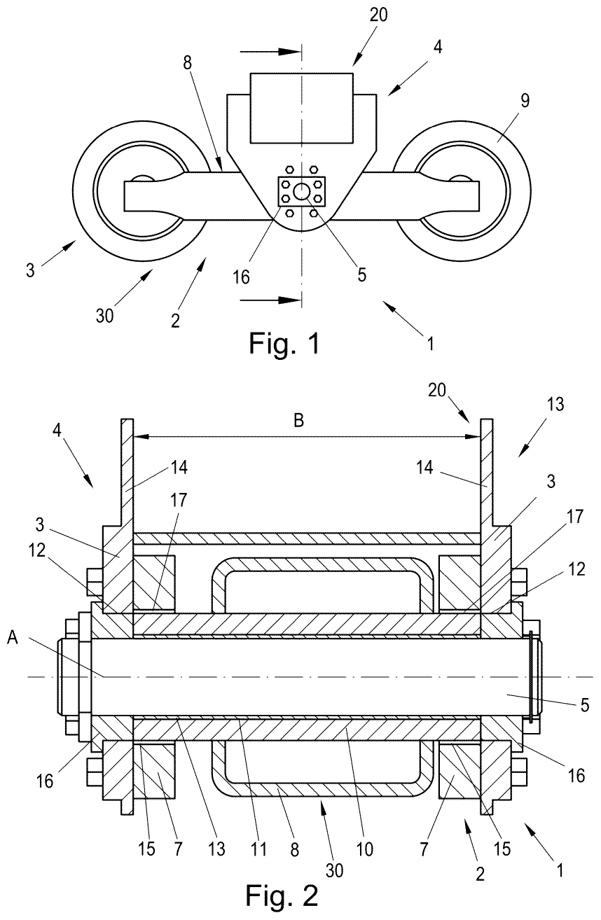

FIG. 1 shows the basic structure of an arrangement 1 for monitoring a bearing 2 of a sheave assembly 3 of a cableway. The cableway is not shown in the figures for reasons of clarity. The sheave assembly 3 can comprise a carrier unit 8 and a number of sheaves 9 that are mounted on the carrier unit 8. The carrier unit 8 is designed as a shaped tube in the embodiment in FIG. 2, although different embodiments and different cross-sections are of course conceivable.

The bearing 2 comprises a receiving component 20 and a component 30 of the sheave assembly 3. The component 30 of the sheave assembly is pivotably mounted on the receiving component 20 by the bearing 2. Different components of a cableway can be used as the receiving component 20. Preferably, the receiving component 20 is an aerial lift pylon 4 or a part of an aerial lift pylon 4. In FIG. 1, the aerial lift pylon 4 is provided as the receiving component 20. Only a part of the aerial lift pylon 4, for example, the cross-member, is shown. The cross-member of the aerial lift pylon 4 can further comprise a holding device that can serve as receiving component 20. However, a part of the sheave assembly 3 can also serve as the receiving component 20, as will be explained further below.

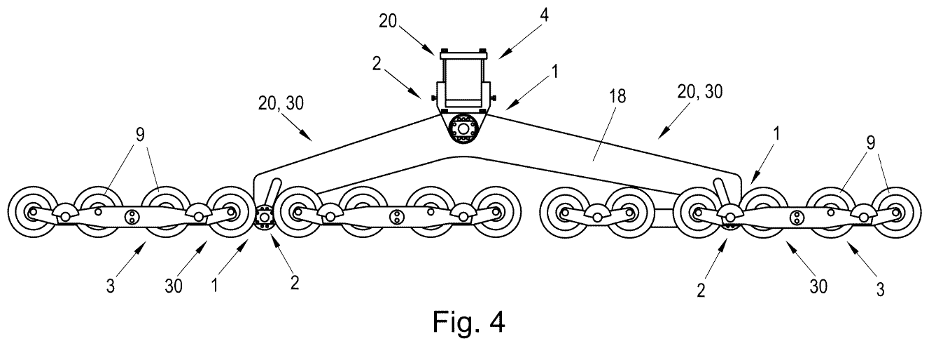

In the embodiment in FIG. 1, the component 30 of the sheave assembly 3 is the carrier unit 8 of the sheave assembly 3 on which the sheaves 9 are mounted. However, a carrier 18 of the sheave assembly 3 can also be used as the component 30 of the sheave assembly 3, as will be explained further below in FIGS. 4 and 5.

FIG. 2 is a sectional view of the bearing 2. The component 30 of the sheave assembly 3 is mounted on the receiving component 20 via a connecting element 5 so as to be pivotable about an axis of rotation A. As shown in FIG. 2, the sheave assembly 3 is pivotably mounted about an axis of rotation A relative to the aerial lift pylon 4 (as receiving component 20), for example via the carrier unit 8 (as component 30 of the sheave assembly 3). For this purpose, the carrier unit 8 of the sheave assembly 3 can have a bearing part 10, wherein a connecting recess 11 is provided in the bearing part 10. As shown in FIG. 2, the bearing part 10 can be designed, for example, as a hollow cylinder that extends through the cross-section of the carrier unit 8.

Preferably, at least one holding recess 12 (e.g., a hole) is provided on the receiving component 20. In the embodiment in FIG. 2, the aerial lift pylon 4 comprises, for example, two side plates 14 as a receiving component 20, wherein a holding recess 12 is provided in each of the side plates 14. Between the side plates 14 there is a receiving region B for the bearing part 10 of the carrier unit 8.

In FIG. 2, the connecting element 5 is inserted through the connecting recess 11 of the bearing part 10 of the carrier unit 8 and through the holding recesses 12 of the aerial lift pylon 4. The sheave assembly 3 with the carrier unit 8 is thus mounted on the aerial lift pylon 4 via the connecting element 5 so that it can pivot about the axis of rotation A. The connecting element 5 can be designed, for example, as a bolt. The connecting element 5 can also comprise a bearing element 13, which is arranged between a peripheral surface of the connecting element 5 and the connecting recess 11 of the bearing part 10. The bearing element 13 can be designed as a hollow cylinder (e.g., a bushing, plain bearing bush).

The connecting element 5 can further have, for example, at least one circumferential groove on the peripheral surface, wherein a securing ring is provided in the circumferential groove, which serves to fix the connecting element 5 in the direction of the axis of rotation A.

Through the bearing 2 of the component 30 of the sheave assembly 3 via the connecting element 5 on the receiving component 20, the sheave assembly 3 is arranged in a target radial position relative to the axis of rotation A. Preferably, the bearing part 10 of the carrier unit 8 of the sheave assembly 3 is arranged coaxially with the axis of rotation A.

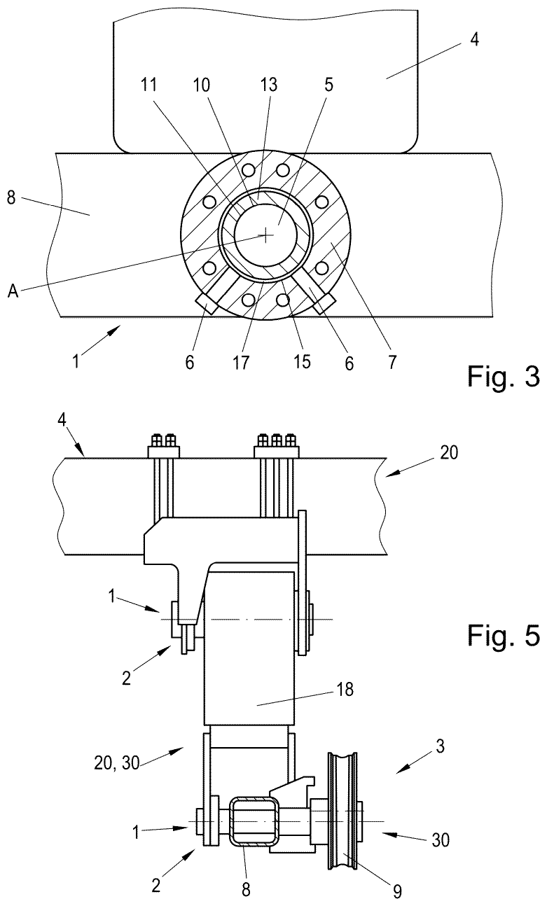

At least one securing element 7 is preferably arranged on the receiving component 20 to prevent a relative movement between the securing element 7 and the receiving component 20 radially to the axis of rotation A, in particular, in the direction of a gravitational force acting on the carrier unit 8. The at least one securing element 7 can be fixedly connected to the receiving component 20, for example, with screws. In the embodiment in FIG. 2, two securing elements 7 are shown. A securing recess 15 is provided on the securing element 7. The shape of the securing recess 15 preferably corresponds to the cross-section of the bearing part 10. In order for the sheave assembly 3 to remain mounted on the receiving component 20 via the at least one securing element 7 in the event of failure of the connecting element 5, the bearing part 10 of the carrier unit 8 is arranged at least partially in the securing recess 15 of the securing element 7. FIG. 3 is a side view of a securing element 7 of the bearing 2. The securing element 7 is represented in a ring shape. Of course, the securing element 7 can be designed with other cross-sections.

Furthermore, the bearing 2 can comprise at least one bearing cover 16, which is fastened to the receiving component 20. In the embodiment of the bearing 2 in FIG. 2, two bearing covers 16 are shown.

At least one sensor 6 is provided in the arrangement 1 in a region of the bearing 2 to detect a radial change in position of the sheave assembly 3 relative to the axis of rotation A from the target radial position. Preferably, the securing element 7 comprises the at least one sensor 6. Of course, the at least one sensor 6 can be arranged at different positions in the region of the bearing 2. The at least one sensor 6 can also be provided on the receiving component 20, for example. In this case, the arrangement 1 can also comprise a plurality of sensors 6. In FIG. 3, for example, two sensors are provided in the securing element 7. Preferably, the at least one sensor 6 is a limit switch or a proximity sensor.

The at least one sensor 6 is designed to interrupt or enable a current flow upon detecting a prespecified radial change in position of the sheave assembly 3 relative to the axis of rotation A from the target radial position in order to trigger an action. For example, a maximum permissible radial change in position of the sheave assembly 3 can be prespecified, for example by the arrangement of the at least one sensor 6, as described below. Upon the detection of the prespecified radial change in position, a current flowing through the sensor 6 can, for example, be interrupted or enabled. In the case of a limit switch as sensor 6, the bearing part 10 or another part of the component 30, for example, a mechanical element of the limit switch, can be actuated in order to interrupt or enable the current flow. The action that is triggered is preferably an alarm signal that is communicated visually and/or acoustically, for example, to cableway personnel in a cableway control room. The alarm signal can also be used to intervene in the cableway control system, for example, to stop the drive of the cableway or to reduce the conveying speed of the cableway.

In FIG. 3, there is a gap 17 between the securing recess 15 of the securing element 7 and the bearing part 10 of the carrier unit 8 of the sheave assembly 3. In this case, the bearing part 10 of the carrier unit 8 and the securing recess 15 of the securing element 7 are arranged coaxially with the axis of rotation A. The two sensors 6 are arranged in the radial direction to the axis of rotation A in the securing element 7 and project into the gap 17. Due to the arrangement of the two sensors, for example, the gap 17 can be prespecified as the maximum permissible change in position of the sheave assembly 3. Should wear of the bearing occur, for example, of the connecting recess 11 of the bearing part 10 or of the connecting element 5 or of the bearing element 13, the bearing part 10 of the carrier unit 8 of the sheave assembly 3 will move radially in the direction of the sensors (due to gravity), whereby the gap closes. The radial change in position of the bearing part 10 is detected by at least one of the sensors 6. In the case of limit switches as sensors 6, the radial change in position of the bearing part 10 results in contact between the bearing part 10 and at least one sensor 6, whereby, for example, a mechanical element of the limit switch is actuated and a current flow through the sensor 6 is interrupted or enabled. With a proximity switch as sensor 6, the prespecified radial change in position of the bearing part 10 can also be detected without contact, for example.

In addition to wear of the bearing 2, a failure of, for example, the connecting element 5 can also trigger a radial change in position of the sheave assembly 3. For this purpose, an acceleration sensor can additionally be provided as at least one sensor 6 in the region of the bearing 2. This makes it possible, for example, to detect a sudden acceleration, which may be characteristic of a fracture of the connecting element 5.

Depending on the arrangement and number of the at least one sensor 6, a tilting of the bearing 2 can be detected. In the case of tilting, for example, the bearing part 10 of the carrier unit 8 is inclined at an angle to the axis of rotation A, in contrast to the coaxial arrangement. The tilting of the bearing 2 can occur, for example, in the event of uneven wear (e.g. due to a one-sided load on the bearing 2) or in the event of failure of the connecting element 5. In the embodiment of the bearing 2 in FIG. 2, two securing elements 7, each having four sensors 6 (one in each quadrant of the securing element 7), could be provided. In the event of a tilting of the bearing part 10, a sensor 6 of each securing element 7 will detect, for example, a radial change in position of the bearing part 10, wherein the two sensors 6 that are arranged in the quadrants opposite to the axis of rotation A in the radial direction respond.

Furthermore, the securing element 7 can also comprise an adjusting element (not shown), for example, a screw. For example, instead of a sensor 6 in FIG. 3, a screw could be provided as the adjusting element. By screwing the screw into the securing element 7, it comes into contact with the bearing part 10, whereby the bearing part 10 is moved in the direction of the axis of rotation A. In particular, this can simplify the insertion of the connecting element 5 into the bearing 2 during installation or maintenance.

FIG. 4 shows a further embodiment of a bearing 2 of a sheave assembly 3 of a cableway. FIG. 5 is a side view of the further embodiment. The sheave assembly 3 additionally comprises a carrier 18 on which a carrier unit 8 having sheaves 9 having a bearing 2 is mounted. In this case, the carrier 18 is the receiving component 20 and the carrier unit 8 of the respective sheave assembly 3 is the component 30 of the sheave assembly 3 of the bearing 2. The carrier 18 of the sheave assembly 3 is in turn mounted on the aerial lift pylon 4 by a further bearing 2. In this bearing 2, the carrier 18 is the component 30 of the sheave assembly 3 and the aerial lift pylon 4 is the receiving component 20. The arrangement 1 according to the invention is preferably provided in each of the bearings 2 in order to monitor them.

It is noted that the foregoing examples have been provided merely for the purpose of explanation and are in no way to be construed as limiting of the present invention. While the present invention has been described with reference to an exemplary embodiment, it is understood that the words which have been used herein are words of description and illustration, rather than words of limitation. Changes may be made, within the purview of the appended claims, as presently stated and as amended, without departing from the scope and spirit of the present invention in its aspects. Although the present invention has been described herein with reference to particular means, materials and embodiments, the present invention is not intended to be limited to the particulars disclosed herein; rather, the present invention extends to all functionally equivalent structures, methods and uses, such as are within the scope of the appended claims.

What is claimed:

1. An arrangement for monitoring a bearing of a sheave assembly of a cableway, wherein the bearing comprises a receiving component and a component of the sheave assembly that is mounted on the receiving component via a connecting element so as to be pivotable about an axis of rotation and the sheave assembly is arranged in a target radial position with respect to the axis of rotation, the arrangement comprising:
at least one sensor arranged in a region of the bearing to detect a radial change in position of the sheave assembly relative to the axis of rotation from the target radial position,
wherein the at least one sensor is designed to one of interrupt or enable a current flow upon detecting a prespecified radial change in position of the sheave assembly relative to the axis of rotation from a target radial position in order to trigger an action.

2. The arrangement according to claim 1, wherein the sheave assembly is a carrier unit of the sheave assembly or a carrier of the sheave assembly.

3. The arrangement according to claim 1, wherein the receiving component is a carrier of the sheave assembly and the component of the sheave assembly is a carrier unit of the sheave assembly.

4. The arrangement according to claim 1, wherein the at least one sensor is a limit switch or a proximity sensor.

5. The arrangement according to claim 1, wherein the receiving component has at least one securing element to bear the sheave assembly on the receiving component via the at least one securing element in the event of failure of the connecting element.

6. The arrangement according to claim 1, wherein the at least one securing element comprises the at least one sensor.

7. A method for monitoring a bearing of a sheave assembly of a cableway having an arrangement according to claim 1, wherein a component of the sheave assembly is mounted on a receiving component via a connecting element so as to be pivotable about an axis of rotation and the sheave assembly is arranged in a target radial position with respect to the axis of rotation, comprising:
detecting, with a sensor arranged in a region of the bearing, a predetermined radial change in position of the sheave assembly relative to the axis of rotation from the target radial position, and
one or interrupting or enabling in the at least one sensor, a current flow, thereby triggering an action.

8. The method according to claim 7, wherein the triggered action generates an alarm signal.
